(19) United States
(12) Patent Application Publication
(10) Pub. No.: US 2026/0094121 A1
(43) Pub. Date: Apr. 2, 2026

(54) Proposal Writing System And Method

(71) Applicants: Sanju Bansal, McLean, VA (US); Vishwas Lele, Great Falls, VA (US)

(72) Inventors: Sanju Bansal, McLean, VA (US); Vishwas Lele, Great Falls, VA (US)

(21) Appl. No.: 19/348,469

(22) Filed: Oct. 2, 2025

Related U.S. Application Data
(60) Provisional application No. 63/702,177, filed on Oct. 2, 2024.

(51) Int. Cl. G06Q 10/101; G06F 40/40; G06Q 10/10

(52) U.S. Cl. CPC G06Q 10/101; G06Q 10/103; G06F 40/40

(57) ABSTRACT

A computerized system for generating digital response documents includes a knowledge repository database of digital knowledge objects, an ingestion subsystem configured to process source materials into structured digital request objects, an object management subsystem configured to generate digital strategy objects based on those inputs, and a response generation subsystem configured to construct annotated outlines and populate response documents using outputs from a large language model (LLM) in response to non-user generated prompts.

### CROSS-REFERENCE TO RELATED APPLICATIONS

This application claims the benefit of priority to U.S. Provisional Ser. No. 63/702,177 filed on Oct. 2, 2024, titled “Proposal Writing System and Method”, the entire contents of which are incorporated herein by reference.

### FIELD OF DISCLOSURE

The present disclosure relates generally to proposal writing systems and methods, and more particularly to computerized systems and methods for generating digital response documents using non-user generated prompts for input into a large language model (LLM).

### RELATED ART

RFx documents (or “requests”) refer to formal solicitations issued by customers (e.g., government agencies, enterprise buyers, or regulated entities) to engage vendors in competitive or exploratory procurement processes. RFx documents may include Requests for Proposal (RFPs), Requests for Quotation (RFQs), Requests for Information (RFIs), Requests for Tender (RFTs), Requests for Bid (RFBs), and other structured solicitations. These documents typically specify requirements, evaluation criteria, submission instructions, and deadlines.

For example, a Request for Proposal (RFP) is a formal solicitation issued by a customer seeking competitive bids for a product or service. RFPs typically include detailed requirements, evaluation criteria, submission instructions, and deadlines. Responding to an RFP requires the bidding organization to prepare a structured proposal that demonstrates technical capability, past performance, and alignment with the customer's stated needs. These responses must be persuasive, compliant, and tailored to the specific goals outlined in the solicitation.

Organizations responding to such RFPs must navigate a complex and demanding proposal development process, balancing strategic messaging, compliance, and collaboration under tight deadlines. A typical RFP response must: (1) present the organization's strengths in a cohesive and persuasive manner, (2) maintain consistency in style, facts, and themes across sections, (3) foster collaboration among contributors and managers, (4) align the offering with the customer's stated vision, (5) adhere to compliance requirements and submission instructions, and (6) meet strict schedules of milestones and deadlines.

The typical process is highly iterative. Proposal teams must repeatedly revise drafts as new information emerges, competitive conditions change, or differentiators are identified. This manual, paragraph-by-paragraph drafting process is time-consuming and prone to inconsistencies, particularly when multiple contributors are involved.

Recent advances in generative artificial intelligence (GenAI) have introduced tools that can accelerate proposal drafting. In a common approach, illustrated in FIG. 1, a proposal professional 10 interacts with a large language model (LLM) through a “wrapper” interface of the LLM 14. For each RFP question, the user 10 must: (1) review the solicitation (“RFP”) 16, (2) craft and optimize a prompt 12, (3) provide contextual information such as pain points, past performance, and solution elements, and (4) submit one or more user generated prompts to the LLM 14. The LLM 14 generates output in response, which the user then reviews, edits, and integrates into the overall proposal 20.

While such wrapper-based systems can accelerate drafting compared to purely manual methods, they remain dependent on continuous human prompting and oversight. Each RFP question or requirement requires a separate prompt, and the resulting responses must be manually reconciled and stitched together into a cohesive document. Even with AI assistance, this paragraph-by-paragraph process bogs down whenever new information arises. Shifting gears or responding to new competitive intelligence requires a manual overhaul, further compounding inefficiency. As a result, existing approaches often yield fragmented proposals with inconsistencies in tone, style, and substance, placing a significant burden on proposal professionals.

The foregoing discussion of related-art proposal development processes and existing AI-assisted approaches is provided for context only. No admission is made that any reference, system, or method described herein constitutes prior art. Furthermore, the identification of any problem or deficiency in the prior approaches should not be construed as an admission that such problem or deficiency was previously recognized in the art.

### SUMMARY

Different aspects of the present disclosure may be provided in differing embodiments. However, a few non-limiting example embodiments are now summarized by way of brief introduction to a novel system and method.

According to an example embodiment, a computerized system for generating a digital response document is disclosed. The system comprises: one or more processors and memory storing instructions that, when executed by the one or more processors, cause the system to perform operations including: accessing a knowledge repository database to retrieve a plurality of digital knowledge objects representing organizational knowledge; receiving, from an ingestion subsystem, a plurality of digital request objects included in a request; generating, by an object management subsystem, a structured proposal framework comprising a plurality of digital strategy objects based on the digital knowledge objects and the digital request objects; and generating, by a response generation subsystem, the digital response document based on the digital strategy objects and on an iterative interaction with a large language model (LLM). The iterative interaction includes inputting sets of non-user generated prompts into the LLM and receiving outputs for each set of prompts.

According to another embodiment, a computerized method for generating a digital response document is disclosed. The method comprises: receiving, from a knowledge repository database, a plurality of digital knowledge objects representing organizational knowledge; receiving, from an ingestion subsystem, a plurality of digital request objects included in a request; generating, by an object management subsystem, a structured proposal framework comprising a plurality of digital strategy objects based on the digital knowledge objects and the digital request objects; and generating, by a response generation subsystem, the digital response document based on the digital strategy objects and on an iterative interaction with a large language model (LLM). The iterative interaction includes inputting sets of non-user generated prompts into the LLM and receiving outputs for each set of prompts.

However, aspects of the disclosure are not limited to the example embodiments described above. Other aspects are described in the following description and will be apparent to those of ordinary skill in the art.

### BRIEF DESCRIPTION OF THE DRAWINGS

The several features, objects, and advantages of exemplary embodiments will be understood by reading this description in conjunction with the drawings. The same reference numbers in different drawings identify the same or similar elements. In the drawings:

FIG. 1 illustrates a user-centric approach to generating a proposal;

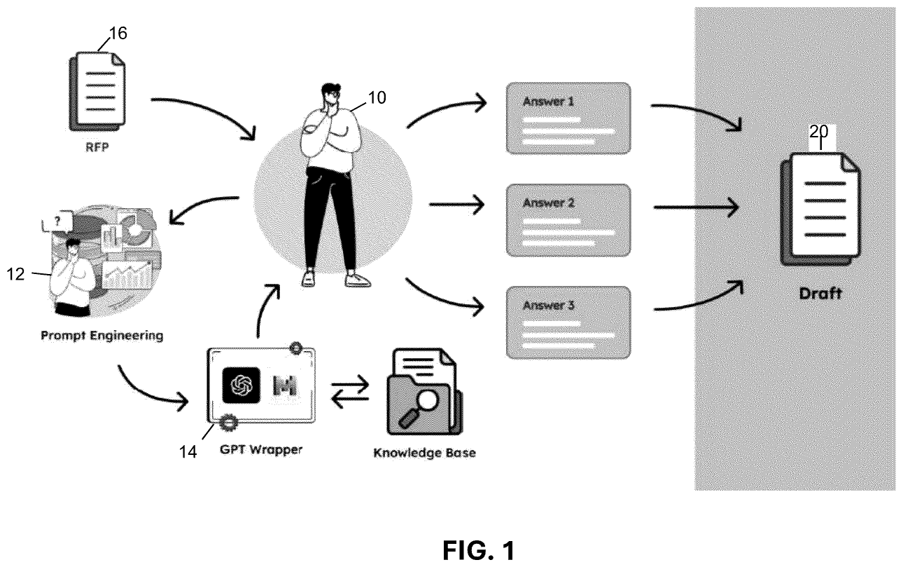

FIG. 2 illustrates a system architecture according to an example embodiment;

FIG. 3 illustrates a computerized system for generating a digital response document according to an example embodiment;

FIG. 4 illustrates a computerized method for generating a digital response document according to an example embodiment;

FIG. 5 illustrates operations for determining and refining a proposal strategy according to an example embodiment;

FIG. 6 illustrates operations for determining and refining an annotated proposal outline according to an example embodiment; and

FIG. 7 illustrates operations for populating a digital response document according to an example embodiment.

### DETAILED DESCRIPTION

The disclosure will now be described more fully hereinafter with reference to the drawings, in which sample embodiments are shown.

However, this disclosure may be embodied in different forms and should not be construed as limited to the embodiments set forth herein.

References to the singular forms “a”, “an”, and “the” are intended to include the plural forms as well, unless the context clearly indicates otherwise. The terms “and” and “or” may be used in the conjunctive or disjunctive sense and may be understood to be equivalent to “and/or”.

When an element is referred to as being “connected to” another element in the specification, the connection may be direct or indirect, with one or more intervening elements disposed therebetween.

Similarly, when data is referred to as being “communicated to”, “input into”, or “received from” an element, such communication may occur directly or through one or more intermediate components, modules, or subsystems.

Unless explicitly stated otherwise, such references are intended to encompass both direct and indirect interactions, including those facilitated by layered, distributed, or modular architectures.

The words “Computerized system” may refer to any combination of computing devices, cloud-hosted services, orchestration modules, and model endpoints configured to perform the operations described herein. The computerized system may include one or more subsystems, components, or services that are logically or physically distinct, and such subsystems may be combined, divided, replicated, or otherwise reconfigured across different deployment environments. Unless explicitly stated otherwise, references to subsystems or modules are not intended to imply fixed boundaries or exclusivity of function.

“Digital knowledge objects” refer to structured data elements derived from internal organizational sources, such as past proposals, capability statements, and performance records.

“Digital request objects” refer to structured data elements extracted from external solicitation documents (or “requests”), including Requests for Proposal (RFPs), Requests for Quotation (RFQs), and related materials.

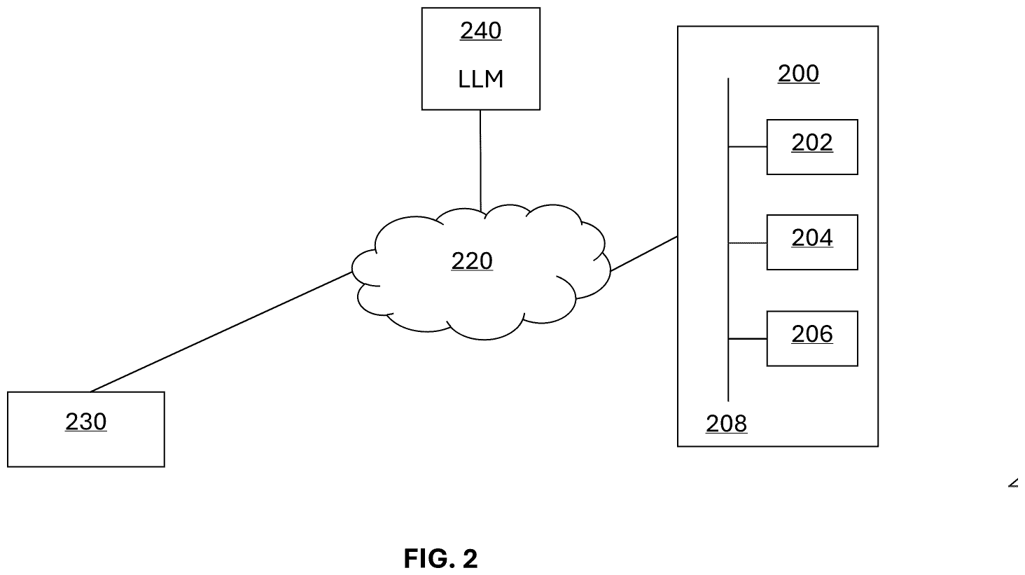

FIG. 2 illustrates an example system architecture according to an example embodiment. A user device 230 may interact with a cloud-based system that includes a computing device 200. The computing device 200 may be one of a plurality of computing devices or subsystems operating within a cloud-hosted environment 220. The cloud 220 may include orchestration modules, storage services, model endpoints, and distributed processing nodes configured to support execution of one or more methods described herein.

The computing device 200 may include one or more processors 202 and memory 204. The memory 204 may store instructions that, when executed by the one or more processors 202, cause the computing device 200 to perform one or more operations described in this disclosure. The computing device 200 may further include an input/output interface 206 and a bus 208 interconnecting the processor 202, memory 204, and input/output interface 206. In various embodiments, the computing device 200 may be instantiated as a virtual machine, containerized service, or dedicated hardware node within the cloud 220. The cloud-hosted environment may include server farms, edge computing nodes, or hybrid deployments spanning public and private cloud infrastructure.

The cloud 220 may further include or interface with a large language model (LLM 240), which may be configured to receive prompt sets and generate outputs used in various stages of document generation. The LLM 240 may be implemented using third-party model endpoints such as ChatGPT™ from OpenAI™, Google® Gemini™, Microsoft® Copilot®, or other commercially available or proprietary models. The LLM 240 may be accessed via API endpoints, orchestration pipelines, or internal service calls, and may operate asynchronously or in real-time depending on system configuration. The LLM may be hosted in an air-gapped environment or deployed across multiple regions for redundancy and compliance.

Connectivity between the user device 230, the computing device 200, and the cloud 220 may be established via wired or wireless communication channels, including but not limited to Ethernet, Wi-Fi, cellular networks, satellite links, or mesh networks. Communications may be secured using encryption protocols, authentication layers, and transport mechanisms such as HTTPS, gRPC, or message queues. The system may support low-latency routing, bandwidth optimization, and failover mechanisms to ensure reliable access and execution.

The user device 230 may comprise a laptop, workstation, mobile device, or other computing interface configured to initiate interactions with the cloud 220. These interactions may include submission of digital request objects, retrieval of generated content, orchestration of automated workflows, or review of synthesized documents. The user device 230 may include a graphical user interface (GUI), voice interface, or API endpoint configured to transmit structured or unstructured input to the cloud 220.

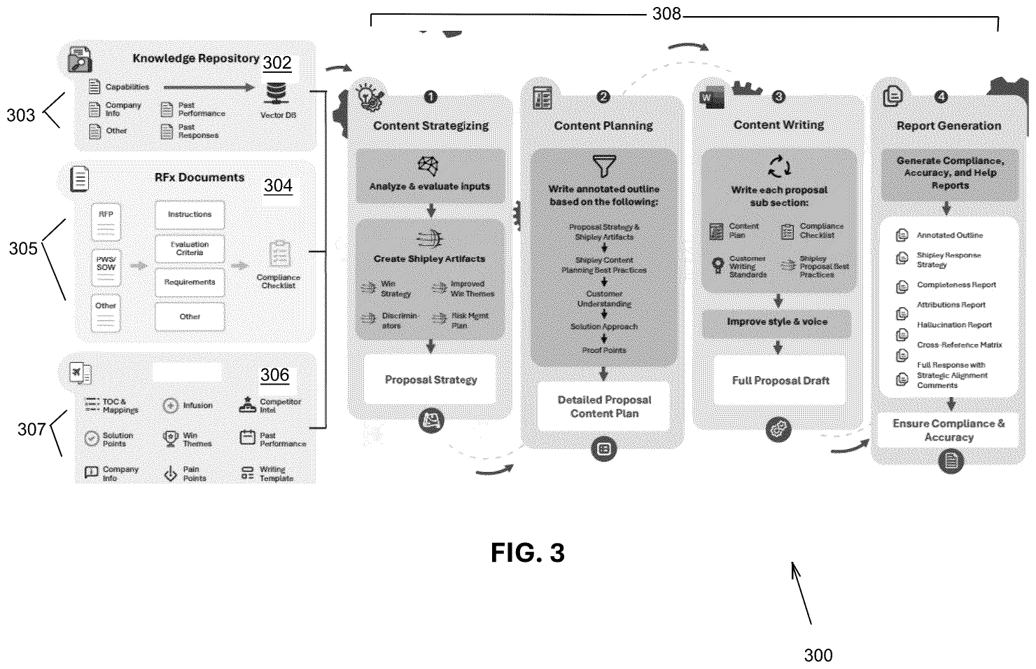

The computing device 200, the cloud 220, and other computing devices may collectively represent a distributed computing environment capable of supporting scalable, modular, and cloud-native implementations of the systems and methods described herein. The distributed computing environment may be configured to support a range of deployment models, including cloud-native, on-premises, and hybrid configurations. Subsystems (e.g. the ingestion subsystem 304, object management subsystem 306, and response generation subsystem 308 of FIG. 3) may be instantiated as containerized services or isolated modules to enable scalability, fault tolerance, and secure data handling. The computerized system of FIG. 3 may integrate with external repositories, proposal portals, or secure enclaves to support compliance, interoperability, and mission-specific constraints. These deployment options may facilitate flexible adoption across regulated industries, distributed teams, and enterprise IT environments.

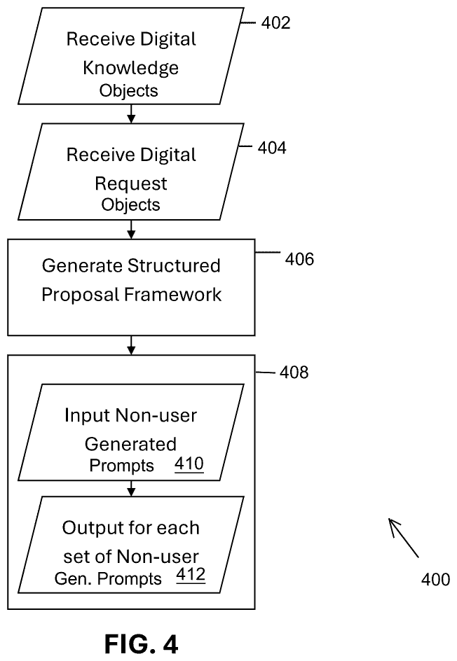

FIG. 3 illustrates a computerized system 300 for generating a digital response document, according to an example embodiment. FIG. 4 illustrates a computerized method 400 for generating a digital response document, according to an example embodiment. As embodied in an architecture similar to that shown in FIG. 2, the computerized system 300 may include one or more processors 202 and memory 204 storing instructions. The computerized system 300 may include a knowledge repository database 302, an ingestion subsystem 304, an object management subsystem 306 and a response generation subsystem 308. The instructions in memory 204 may, when executed by the one or more processors 202, cause the computerized system 300 to perform a method such as the method 400 illustrated in FIG. 4.

At operation 402, the computerized system 300 may access the knowledge repository database 302 to retrieve (or receive) multiple digital knowledge objects 303. The knowledge repository subsystem 302 may be configured to store data unique to a user's organization, including documents such as organization information, past proposal responses (e.g., Request for Proposal (RFP) responses), capability statements, and performance records (e.g., Contractor Performance Assessment Reports (CPARs)). These documents may be digitized if necessary and processed to extract digital knowledge objects (i.e., KR objects). The extracted objects may be transformed into embeddings and stored in a vector database for semantic retrieval and prompt augmentation. The computerized system 300 may receive a plurality of the digital knowledge objects 303 at operation 402, the plurality including at least two different types of objects.

As described with reference to FIG. 2, communications between system components may be secured using encryption protocols and authentication layers. Building on this foundation, the knowledge repository database 302 may operate within a secure computing environment that enforces access controls, data-at-rest encryption, and audit logging. Access to the repository may be restricted to authenticated users and authorized subsystems, with role-based permissions governing ingestion, retrieval, and curation of digital knowledge objects. Secure user interaction with the repository may be supported via graphical user interfaces, API endpoints, or orchestration workflows, enabling users to contribute, review, or refine organizational knowledge while preserving data integrity and confidentiality.

It will be appreciated that, although the present disclosure primarily references Requests for Proposal (RFPs), other RFx documents (e.g., Requests for Quotation (RFQs), Requests for Tender (RFTs), and Requests for Information (RFIs)) may be substituted in various embodiments as so-called requests. Accordingly, references to RFPs herein are illustrative and not intended to limit the scope of the claims, unless explicitly stated otherwise.

Referring back to FIGS. 3 and 4, the method 400 may proceed to operation 404. More specifically, the computerized system 300 may receive multiple digital request objects 305 from the ingestion subsystem 304. The request objects may be included in (or as part of) a request. That is, the ingestion subsystem 304 may receive RFP documents, may digitize any such RFP documents (if necessary), and may ingest the digital request objects 305 into the system 300. Additional and/or alternative inputs such as Performance Work Statements (PWS), Statements of Work (SOW), and other solicitation-related materials may also be ingested. The ingestion subsystem 304 may process these documents to extract digitized request objects that are representative of request-relevant content. Such objects may include instructions, evaluation criteria, compliance requirements, and other inputs. The computerized system 300 may receive a plurality of the digital request objects 305 at operation 404, the plurality including at least two different types of objects.

The method 400 may proceed to operation 406. At operation 406, the object management subsystem 306 may generate a structured proposal framework including multiple digital strategy objects 307. The strategy objects 307 may be based on the digital request objects 303 and the digital knowledge objects 305.

The object management subsystem 306 may generate the structured proposal framework including the digital strategy objects 307.

These strategy objects may include a table of contents, solution points, organization information, instructions and evaluation criteria, compliance requirements, past performance data, thematic elements (e.g., win themes), customer pain points, and competitor intelligence. The object management subsystem 306 may generate a plurality of the digital request objects 305 at operation 404, the plurality including at least two different types of objects. As part of the operation 406 of generating the structured proposal framework, the object management subsystem 306 may further support user interaction for editing, tagging, and refining strategy objects prior to draft generation.

The method 400 may proceed to operation 408, in which a response generation subsystem 308 may generate the digital response document based on the digital strategy objects 307 and based on iterative interaction with a large language model (LLM). More specifically, iterative interaction with the LLM may include operations 410 and 412. In operation 410, sets of non-user generated prompts (prompts not generated by users) may be input into the LLM. In operation 412, output for each set of the non-user generated prompts may be received from the LLM.

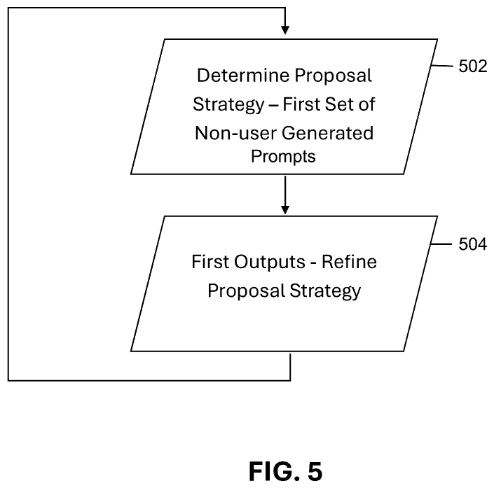

FIG. 5 illustrates operations for determining a proposal strategy, according to an example embodiment. In operation 502, the response generation subsystem 308 may determine the proposal strategy based on multiple digital strategy objects 307 and on a system-implemented proposal management methodology and set of instructions for generating a first set of non-user generated prompts. The first set of non-user generated prompts may be part of the sets of non-user generated prompts generated in operation 410 of FIG. 4. The method may proceed to operation 504 in which the proposal strategy may be refined based on first outputs responsive to the first set of non-user generated prompts. The first outputs may be part of the output received from the LLM in operation 412 of FIG. 4.

The proposal management methodology may be implemented with a set of instructions (e.g., rules). The proposal management methodology may include a set of artifacts, such as win strategies, differentiators, improved win themes, and risk management plans. The response generation subsystem 308 may utilize the implemented proposal management methodology-including relevant artifacts-together with the encoded instructions to generate the first set of non-user generated prompts. The first set of non-user generated prompts may be structured to support development of the proposal strategy based on the plurality of strategy objects. By combining strategy objects with the system-implemented methodology and instructions, the system may produce context-rich prompts that yield more targeted and coherent outputs than ad hoc user-generated prompts, resulting in more consistent and strategically aligned LLM outputs that foster improved proposal strategy refinement.

The system-implemented proposal management methodology may be based on industry-standard frameworks, such as the Shipley® Method. For example, the methodology may include artifacts and encoded instructions aligned with Shipley® principles, including customer-focused strategies, compliance matrices, win themes, and risk mitigation plans. References to the Shipley® Method herein are illustrative and not intended to limit the scope of the claims, and other proposal development methodologies may be substituted in various embodiments. The system may implement such methodologies programmatically to guide prompt generation, strategy refinement, and outline construction in a consistent and repeatable manner.

The prompts may be constructed using template fragments, syntactic rules, or phrase scaffolds defined by the instructions, and may incorporate variables or references to specific strategy objects. As a rudimentary example, an instruction may specify a prompt fragment such as “give us”, which may be programmatically combined with a variable referencing the customer pain points object to yield a complete prompt such as “give us the top three customer pain points”. This compositional approach enables the system to generate context-aware prompts that reflect both strategic intent and proposal-specific content.

The response generation subsystem 308 may responsively generate one or more prompts structured to elicit strategic guidance from the LLM as part of the first set of non-user generated prompts. These prompts may incorporate contextual signals derived from the strategy objects, the system-implemented methodology, and the encoded instructions, thereby enabling the LLM to produce outputs that are tailored to the proposal's strategic posture.

The response generation subsystem 308 may derive differentiators by synthesizing multiple digital strategy objects 307. As a non-limiting example, the response generation subsystem 308 may consider customer pain points, competitor intelligence, and past performance data. In this example, the subsystem may identify a recurring customer pain point (e.g., delayed onboarding) and correlate it with internal performance records showing accelerated deployment timelines. Simultaneously, competitor intelligence may reveal that rival vendors lack automation in onboarding workflows. By combining these strategy objects, the subsystem may generate a differentiator such as “automated onboarding in under 48 hours”, which directly addresses the customer's pain point while highlighting a competitive advantage. This derivation process may be implemented as part of the proposal strategy refinement in operation 504 of FIG. 5, and may inform the generation of context-aware prompts used in subsequent outline and document population phases. Differentiators may be tagged within the annotated proposal outline to ensure consistent emphasis across the digital response document.

The response generation subsystem 308 may further be configured to refine the proposal strategy based on the first outputs responsive to the first set of non-user generated prompts. Such refinement may include adjusting thematic emphasis, modifying differentiators, reordering solution points, or aligning proposal content more closely with evaluation criteria. The refinement process may be iterative, with successive LLM outputs informing progressive adjustments to the proposal strategy until a target alignment threshold is met. This automated refinement loop may enhance strategic coherence and reduce reliance on manual intervention during early-stage proposal development.

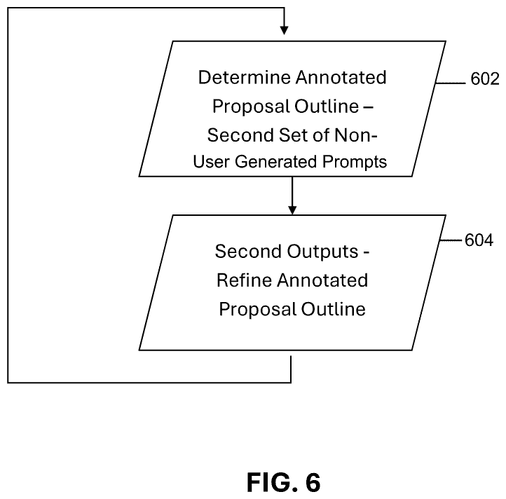

FIG. 6 illustrates the operations for determining and refining an annotated proposal outline, according to an example embodiment. In operation 602, the response generation subsystem 308 may determine the annotated proposal outline based on the refined proposal strategy. The annotated proposal outline may align with the digital request objects 305 and the refined proposal strategy resulting from operations 502 and 504 of FIG. 5, and may be used to generate a second set of non-user generated prompts. The second set of non-user generated prompts may be part of the sets of non-user generated prompts generated in operation 410 of FIG. 4. In operation 604, the annotated proposal outline may be refined based on second outputs responsive to the second set of non-user generated prompts. The second outputs may be received from the LLM as part of the iterative interaction described in operation 412 of FIG. 4.

The annotated proposal outline may include section-level metadata, alignment tags, and embedded strategy object references. For example, each section of the outline may be tagged with one or more digital request objects (e.g., evaluation criteria, compliance requirements) and one or more digital strategy objects (e.g., solution points, differentiators, win themes). These tags may be used to guide prompt generation and ensure that each portion of the response document reflects both customer expectations and organizational strengths. The outline may further include structural elements such as headings, subheadings, and narrative scaffolds, which may be refined based on LLM outputs to improve clarity, persuasiveness, and compliance. The refinement process may include reordering sections, adjusting emphasis, or incorporating additional strategy objects to strengthen alignment with the refined proposal strategy.

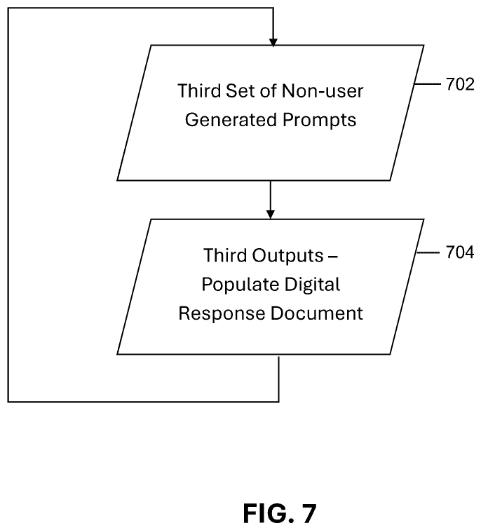

FIG. 7 illustrates the operations for populating the digital response document, according to an example embodiment. In operation 702, the response generation subsystem 308 may generate a third set of non-user generated prompts, each corresponding to a portion of the digital response document as defined by the refined annotated proposal outline. In operation 704, the response generation subsystem 308 may populate each portion of the digital response document based on third outputs responsive to the third set of non-user generated prompts. The third set of non-user generated prompts and the third outputs responsive thereto may be part of the iterative interaction described in operation 408 of FIG. 4, and the third outputs may be aligned with the digital request objects 305 and the refined proposal strategy resulting from operations 502 and 504 of FIG. 5.

Each portion of the digital response document may correspond to a section defined in the annotated proposal outline and may be populated using third outputs that reflect both strategic alignment and compliance fidelity. The response generation subsystem 308 may structure the third set of non-user generated prompts to elicit section-specific content, incorporating contextual signals such as evaluation criteria, customer pain points, and differentiators. These prompts may be programmatically varied to avoid repetition and may include embedded references to strategy objects and request objects relevant to each section. The third outputs may be reviewed, filtered, or scored using system-implemented quality assurance logic to ensure consistency in tone, style, and substance across the document. The response generation subsystem 308 may support user interaction for reviewing and refining populated sections, enabling collaborative editing while preserving the strategic coherence established during earlier operations.

The computerized system 300 may support a structured user feedback loop to enable iterative refinement of the digital response document and associated strategy objects. Users may review, approve, or revise generated content at various stages, including strategy formulation, outline construction, and document population. The system may capture user feedback through graphical interfaces, comment threads, or structured approval workflows, and may maintain revision history, approval states, and change annotations. In response to user feedback, the system may trigger regeneration of specific sections, refinement of strategy objects, or re-alignment with request objects. This feedback loop may ensure that the final response reflects both system-generated guidance and human judgment, while preserving traceability and strategic coherence.

The response generation subsystem 308 may be further configured to verify the outputs received from the first LLM using a second LLM. This verification may be performed by generating non-user generated challenge prompts designed to elicit evaluative, diagnostic, or corroborative responses from the second LLM. The challenge prompts may be structured to test factual consistency, strategic alignment, completeness, and attribution fidelity across the digital response document. Based on the outputs received from the second LLM, the system may generate a digital supporting document corresponding to the digital response document. The supporting document may include summarization of the second LLM outputs and may comprise one or more verification artifacts, such as the annotated proposal outline, the Shipley® response strategy, a completeness report, an attributions report, a hallucinations report, a cross-reference matrix, and the full digital response with embedded alignment comments. These artifacts may be used to support internal review, compliance validation, and stakeholder transparency.

The non-user generated challenge prompts may be categorized into types, such as factual validation prompts, strategic alignment prompts, compliance verification prompts, and hallucination detection prompts. Each prompt type may be designed to elicit targeted diagnostic responses from the second LLM, enabling the system to assess specific dimensions of the digital response document. The outputs from the second LLM may be scored or annotated based on criteria such as consistency, relevance, completeness, and attribution fidelity. These scores or annotations may be incorporated into the digital supporting document to provide reviewers with structured insight into the strengths and weaknesses of the generated response. The system may apply threshold logic or filtering rules to flag sections requiring further review or refinement.

The computerized system 300 may be configured to export the digital response document and its associated supporting artifacts in one or more delivery-ready formats. These formats may include PDF, DOCX, HTML, or JSON, depending on the requirements of the recipient system or review process. The export operation may preserve embedded annotations, alignment comments, and verification summaries, enabling downstream stakeholders to access both the generated content and its supporting rationale. The system may transmit the exported documents via secure channels, integrate with external proposal portals, or store them in designated repositories for archival and compliance purposes.

The computerized system 300 may support traceability of generated content to its originating digital request objects, digital knowledge objects, and digital strategy objects. The system may embed alignment comments, source references, and attribution metadata within the digital response document and its supporting artifacts. These annotations may enable reviewers to audit the rationale behind specific response elements, verify compliance with evaluation criteria, and assess strategic alignment. The system may maintain a structured audit trail of object transformations, prompt lineage, and user interactions, supporting transparency, reproducibility, and regulatory compliance.

According to embodiments of the disclosure, an improved computerized system for generating digital response documents is provided. The system implements a modular proposal object lifecycle that spans ingestion, strategy formulation, outline construction, response generation, verification, and export. This lifecycle enables consistent reuse of digital request objects, digital knowledge objects, and digital strategy objects across phases, supporting semantic alignment and strategic coherence.

The system generates annotated outlines and populates response documents using outputs from a large language model (LLM) in response to non-user generated prompts. This approach eliminates reliance on user-authored prompt engineering, reducing variability and improving reproducibility across generated responses. By decoupling prompt construction from end-user input, the system ensures that generated content aligns with predefined strategic, compliance, and attribution objectives.

Each response element may be traceable to its originating request object, knowledge object, and strategy directive. Supporting artifacts may include alignment comments, verification summaries, and annotated outlines that clarify the relationship between system-generated content and source materials. This traceability enables reviewers to audit the rationale behind specific response elements and assess attribution fidelity.

The system architecture supports collaborative editing, structured feedback loops, and secure export of delivery-ready documents in formats such as PDF, DOCX, HTML, or JSON. Deployment options include cloud-native, on-premises, and hybrid configurations, with subsystem isolation and containerization enabling scalability, fault tolerance, and secure data handling. These features facilitate adoption across regulated industries, distributed teams, and mission-critical workflows.

Collectively, these advantages reflect a coordinated system architecture that integrates structured object management, subsystem orchestration, and LLM-driven content generation into a unified operational framework. The system performs specific technical transformations across distinct phases, from ingestion and strategy formulation to verification and export, each grounded in modular object relationships and deterministic logic. By aligning digital request, knowledge, and strategy objects with annotated outlines and challenge-driven verification, the system delivers consistent, traceable, and delivery-ready outputs that support real-world proposal workflows. These capabilities extend beyond generalized information processing, enabling targeted document generation with embedded compliance, strategic alignment, and auditability.

A few example embodiments have been disclosed herein and are not for purposes of limitation. It is apparent to one of ordinary skill in the art that elements of the embodiments may be combined. It is apparent to one of ordinary skill in the art that various changes in form and details of the embodiments may be made without departing from the spirit and scope of the disclosure.

What is claimed is:

1. A computerized system for generating a digital response document, the computerized system comprising:
one or more processors; and
memory storing instructions that, when executed by the one or more processors, cause the computerized system to perform operations comprising:
accessing a knowledge repository database to retrieve a plurality of digital knowledge objects, the knowledge objects representing organizational knowledge;
receiving, from an ingestion subsystem, a plurality of digital request objects, the request objects being included in a request;
generating, by an object management subsystem, a structured proposal framework including a plurality of digital strategy objects, the strategy objects being based on the plurality of knowledge objects and on the plurality of request objects; and
generating, by a response generation subsystem, the digital response document based on the digital strategy objects and on an iterative interaction with a large language model (LLM), wherein the iterative interaction further comprises:
inputting sets of non-user generated prompts into the LLM; and
receiving an output for each set of the non-user generated prompts from the LLM.

2. The computerized system of claim 1, wherein the response generation subsystem is further configured to:
determine a proposal strategy based on the plurality of digital strategy objects and on a system-implemented proposal management methodology and set of instructions for generating a first set of non-user generated prompts; and
refine the proposal strategy based on first outputs responsive to the first set of non-user generated prompts.

3. The computerized system of claim 2, wherein the response generation subsystem is further configured to:
determine an annotated proposal outline based on the refined proposal strategy, the annotated proposal outline aligning with the digital request objects and the refined proposal strategy, for generating a second set of non-user generated prompts; and
refine the annotated proposal outline based on second outputs responsive to the second set of non-user generated prompts.

4. The computerized system of claim 3, wherein the response generation subsystem is further configured to:
generate a third set of non-user generated prompts, each corresponding to a portion of the digital response document as defined by the refined annotated proposal outline; and
populate each portion of the digital response document based on third outputs responsive to the third set of non-user generated prompts, according to the refined annotated proposal outline and aligned with the digital request objects and the refined proposal strategy.

5. The computerized system of claim 4, wherein the plurality of digital knowledge objects are each selected from a group consisting of organization information, past proposal documents, capability statements, and performance records, the plurality including at least two different members of the group.

6. The computerized system of claim 4, wherein the plurality of digital request objects are each selected from a group consisting of instructions, evaluation criteria, and compliance requirements, the plurality including at least two different members of the group.

7. The computerized system of claim 4, wherein the plurality of digital strategy objects are each selected from a group consisting of a table of contents, solution points, organization information, instructions and evaluation criteria, compliance requirements, past performance data, thematic elements, customer pain points, and competitor intelligence, the plurality including at least two different members of the group.

8. The computerized system of claim 7, wherein
differentiators are used in at least one of the determining of the proposal strategy and the determining of the annotated proposal outline; and
the differentiators are derived based on a plurality of digital strategy objects selected from a group consisting of: the solution points strategy object, the instructions and evaluation criteria strategy object, the compliance requirements strategy object, the past performance strategy object, the customer pain points strategy object, the organization information strategy object, and the competitor intelligence strategy object, the plurality including at least two different members of the group.

9. The computerized system of claim 1, wherein the response generation subsystem is further configured to:
generate non-user generated challenge prompts to interact with a second large language model (LLM) to verify the outputs received from the first LLM; and
generate a digital supporting document corresponding to the digital response document, the supporting document including summarization of outputs from the second LLM received in response to the non-user generated challenge prompts.

10. A computerized method for generating a digital response document, the computerized method comprising:
receiving a plurality of digital knowledge objects, the knowledge objects representing organizational knowledge;
receiving a plurality of digital request objects, the request objects being included in a request;
generating a structured proposal framework including a plurality of digital strategy objects, the strategy objects being based on the plurality of knowledge objects and on the plurality of request objects; and
generating the digital response document based on the digital strategy objects and on an iterative interaction with a large language model (LLM), wherein the iterative interaction further comprises:
inputting sets of non-user generated prompts into the LLM; and
receiving an output for each set of the non-user generated prompts from the LLM.

11. The computerized method of claim 10, wherein the generation of the digital response document comprises:
determining a proposal strategy based on the plurality of digital strategy objects and on a system-implemented proposal management methodology and set of instructions for generating a first set of non-user generated prompts; and
refining the proposal strategy based on first outputs responsive to the first set of non-user generated prompts.

12. The computerized method of claim 11, wherein the generation of the digital response document comprises:
determining an annotated proposal outline based on the refined proposal strategy, the annotated proposal outline aligning with the digital request objects and the refined proposal strategy, for generating a second set of non-user generated prompts; and
refining the annotated proposal outline based on second outputs responsive to the second set of non-user generated prompts.

13. The computerized method of claim 12, wherein the generation of the digital response document comprises:
generating a third set of non-user generated prompts, each corresponding to a portion of the digital response document as defined by the refined annotated proposal outline; and
populating each portion of the digital response document based on third outputs responsive to the third set of non-user generated prompts, according to the refined annotated proposal outline and aligned with the digital request objects and the refined proposal strategy.

14. The computerized method of claim 13, wherein the plurality of digital knowledge objects are each selected from a group consisting of organization information, past proposal documents, capability statements, and performance records, the plurality including at least two different members of the group.

15. The computerized method of claim 13, wherein the plurality of digital request objects are each selected from a group consisting of instructions, evaluation criteria, and compliance requirements, the plurality including at least two different members of the group.

16. The computerized method of claim 13, wherein the plurality of digital strategy objects are each selected from a group consisting of a table of contents, solution points, organization information, instructions and evaluation criteria, compliance requirements, past performance data, thematic elements, customer pain points, and competitor intelligence, the plurality including at least two different members of the group.

17. The computerized method of claim 16, wherein
differentiators are used in at least one of the determining of the proposal strategy and the determining of the annotated proposal outline, and
the differentiators are derived based on a plurality of digital strategy objects selected from a group consisting of: the solution points strategy object, the instructions and evaluation criteria strategy object, the compliance requirements strategy object, the past performance strategy object, the customer pain points strategy object, the organization information strategy object, and the competitor intelligence strategy object, the plurality including at least two different members of the group.

18. The computerized method of claim 10, wherein the plurality of digital knowledge objects are received from a knowledge repository database, and wherein the plurality of digital request objects are received from an ingestion subsystem.

19. The computerized method of claim 10, wherein the iterative interaction with the LLM comprises:
generating non-user generated challenge prompts to interact with a second LLM to verify the outputs received from the LLM.

20. The computerized method of claim 19, further comprising:
generating a digital supporting document corresponding to the digital response document, the supporting document including summarization of outputs from the second LLM received in response to the non-user generated challenge prompts.
